(19) United States
(12) Patent Application Publication
(10) Pub. No.: US 2024/0190783 A1
(43) Pub. Date: Jun. 13, 2024

(54) METHOD FOR MANUFACTURING METAL-IMPREGNATED CERAMIC FIRED BODY

(71) Applicants: NGK INSULATORS, LTD., Nagoya-City (JP); NGKADREC COMPANY, Mitake-Cho (JP)

(72) Inventors: Sora GOTO, Komaki-Shi (JP); Shuhei KUNO, Komaki-Shi (JP); Hiroomi MATSUBA, Mizunami-Shi (JP)

(73) Assignees: NGK INSULATORS, LTD., Nagoya-City (JP); NGKADREC COMPANY, Mitake-Cho (JP)

(21) Appl. No.: 18/514,087

(22) Filed: Nov. 20, 2023

(30) Foreign Application Priority Data
Dec. 8, 2022 (JP) 2022-196611

(51) Int. Cl. C04B 41/88; C04B 35/565; C04B 41/00; C04B 41/51

(52) U.S. Cl. CPC C04B 41/88; C04B 35/565; C04B 41/0072; C04B 41/51; F28F 2255/06

(57) ABSTRACT

A method for manufacturing a metal-impregnated ceramic fired body includes: a preparation step 1 for a first metal-impregnated ceramic fired body, including impregnating a ceramic formed body with a metal by heating to a melting point of the metal or higher; and a preparation step 2 for a second metal-impregnated ceramic fired body having a lower metal impregnation amount than the first metal-impregnated ceramic fired body, including removing a part of the metal impregnated in the first metal-impregnated ceramic fired body by reheating the first metal-impregnated ceramic fired body to the melting point of the metal or higher.

### CROSS REFERENCE TO RELATED APPLICATIONS

The present invention claims the benefit of priority to Japanese Patent Application No. 2022-196611 filed on Dec. 8, 2022 with the Japanese Patent Office, the entire contents of which are incorporated herein by reference in its entirety.

### FIELD OF THE INVENTION

The present invention relates to a method for manufacturing a metal-impregnated ceramic fired body.

### BACKGROUND OF THE INVENTION

A method of manufacturing a metal-impregnated ceramic fired body by firing a ceramic formed body while impregnating it with a molten metal is known. Examples of metal-impregnated ceramic fired bodies include silicon-impregnated silicon carbide. Silicon impregnated silicon carbide is known as a material with high thermal conductivity, low thermal expansion, high strength, heat resistance, and oxidation resistance, and conventionally, it is used for applications such as heat exchangers, heat sinks, members for semiconductor devices, refractory materials, and filters for purifying exhaust gases.

Patent Literature 1 (International Publication No. 2011/145387) describes a method for manufacturing a Si—SiC composite material, characterized in that the method uses a body to be impregnated containing SiC and an impregnating metal supplying body containing Si, at least one of the body to be impregnated and the impregnating metal supplying body containing Al, and the method comprises an impregnation step of impregnating the body to be impregnated with a molten metal containing Si from the impregnating metal supplying body in an inert gas atmosphere at normal pressure and in a temperature range of 1200° C. or higher and 1600° C. or lower. Patent Literature 1 describes that, as a specific impregnation method, a press-molded impregnating metal supplying body is placed on a body to be impregnated, which is a formed body, and heat treatment is performed to melt the impregnating metal supplying body and impregnate the body to be impregnated.

Patent Literature 2 (International Publication No. 2021/171670) describes a method for manufacturing a honeycomb formed body containing Si-impregnated SiC composite material as a main component, and a method of arranging a lump containing metal Si and a honeycomb formed body so as to be in contact with each other and firing them is illustrated.

Patent Literature 3 (Japanese Patent Application Publication No. 2017-218342) describes a method for manufacturing a honeycomb structure, the method comprising a forming step for obtaining a formed body; a degreasing step of removing the organic binder contained in the formed body to obtain a degreased body; and an impregnation step of impregnating a peripheral wall and an interior of partition walls of the degreased body with metallic silicon. Patent Literature 3 describes that in the impregnation step, it is preferable to heat the degreased body in a state in which a lump of metallic silicon is in contact with the degreased body.

### PRIOR ART

### Patent Literature

[Patent Literature 1] International Publication No. 2011/145387
[Patent Literature 2] International Publication No. 2021/171670
[Patent Literature 3] Japanese Patent Application Publication No. 2017-218342

### SUMMARY OF THE INVENTION

As described in Patent Literature 1 to 3, in conventional methods for manufacturing a metal-impregnated ceramic fired body, an impregnation step is carried out by heat-treating in a state in which a ceramic formed body to be impregnated and an impregnating metal supplying formed body are in contact, typically, a state in which the impregnating metal supplying formed body is placed on the ceramic formed body to be impregnated.

However, conventionally, in the impregnation step, if an excessive amount of the impregnating metal supplying formed body is loaded, the residue of the impregnating metal supplying formed body may stick to the impregnated ceramic formed body at the contact surface, thereby causing sticking. Since the sticking residue is firmly adhered by melting of the impregnating metal supplying formed body, the impregnated ceramic formed body may be damaged during its removal, which causes a decrease in yield.

In addition, conventionally, in the impregnation step, even if sticking does not occur, the impregnation amount of the metal-impregnated ceramic fired body may be excessive. However, since there has been no method for adjusting the impregnation amount in the case of excessive impregnation, this has been a cause of low yield. Therefore, it would be desirable to provide a method for adjusting the impregnation amount.

The present invention has been made in view of the above circumstances, and in one aspect, one object of the present invention is to provide a method for manufacturing a metal-impregnated ceramic fired body that can contribute to an improvement in product yield.

The inventors of the present invention have made extensive studies to solve the above problems, and found that the sticking can be removed and the impregnation amount can be adjusted by reheating the metal-impregnated ceramic fired body. The present invention has been created based on this knowledge, and is exemplified as below.

### [Aspect 1]

A method for manufacturing a metal-impregnated ceramic fired body, comprising:
a preparation step 1 for a first metal-impregnated ceramic fired body, comprising impregnating a ceramic formed body with a metal by heating to a melting point of the metal or higher; and
a preparation step 2 for a second metal-impregnated ceramic fired body having a lower metal impregnation amount than the first metal-impregnated ceramic fired body, comprising removing a part of the metal impregnated in the first metal-impregnated ceramic fired body by reheating the first metal-impregnated ceramic fired body to the melting point of the metal or higher.

### [Aspect 2]

The method according to aspect 1, wherein the first metal-impregnated ceramic fired body comprises one or two or more protrusions formed by the metal protruding on a surface.

### [Aspect 3]

The method according to aspect 1 or 2, wherein a maximum temperature during the reheating in the preparation step 2 is higher than a maximum temperature during the heating in the preparation step 1.

### [Aspect 4]

The method according to any one of aspects 1 to 3, wherein a pressure of an ambient gas during the reheating in the preparation step 2 is lower than a pressure of the ambient gas during the heating in the preparation step 1.

### [Aspect 5]

The method according to any one of aspects 1 to 4, wherein the preparation step 2 comprises reheating the first metal-impregnated ceramic fired body while bringing an absorbent into contact with the first metal-impregnated ceramic fired body, thereby causing the absorbent to absorb the metal impregnated in the first metal-impregnated ceramic fired body.

### [Aspect 6]

The manufacturing method according to aspect 5, wherein the absorbent is porous.

### [Aspect 7]

The method according to aspect 5 or 6, wherein the reheating in the preparation step 2 is performed with the absorbent placed on and/or under the first metal-impregnated ceramic fired body.

### [Aspect 8]

The method according to any one of aspects 5 to 7, wherein the absorbent contains 80% by mass or more in total of one or more selected from silicon carbide, carbon, and ceramic materials contained in the ceramic formed body.

### [Aspect 9]

The method according to any one of aspects 1 to 8, wherein the ceramic formed body comprises a honeycomb structure portion having an outer peripheral wall and partition walls disposed on an inner peripheral side of the outer peripheral wall and partitioning a plurality of cells forming flow paths from one end surface to another end surface.

### [Aspect 10]

The method according to any one of aspects 1 to 9, wherein the ceramic formed body contains silicon carbide, and the metal contains metallic silicon.

### [Aspect 11]

The method according to any one of aspects 1 to 10, wherein the metal-impregnated ceramic fired body is a heat exchanger.

### [Aspect 12]

The method according to any one of aspects 1 to 11, wherein the metal-impregnated ceramic fired body has a porosity of 30% or less.

According to the method for manufacturing a metal-impregnated ceramic fired body according to one embodiment of the present invention, it is possible to remove sticking and adjust the impregnation amount by reheating the metal-impregnated ceramic fired body. Therefore, even if the impregnated metal sticks to the metal-impregnated ceramic fired body, or if the impregnation amount of the metal-impregnated ceramic fired body becomes excessive, it can be corrected to a metal-impregnated ceramic fired body with an appropriate impregnation amount.

Therefore, the method for manufacturing a metal-impregnated ceramic fired body according to one embodiment of the present invention can contribute to an improvement in yield when manufacturing a metal-impregnated ceramic fired body.

### BRIEF DESCRIPTION OF THE DRAWINGS

FIG. 1 shows a schematic perspective view of an example of a ceramic formed body;

FIG. 2 shows a schematic perspective view of another example of a ceramic formed body;

FIG. 3A is a schematic side cross-sectional view showing a state in which an absorbent is placed on a first metal-impregnated ceramic fired body;

FIG. 3B is a schematic side cross-sectional view showing a state in which a first metal-impregnated ceramic fired body is placed on an absorbent.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

According to one embodiment of the present invention, the method for manufacturing a metal-impregnated ceramic fired body comprises:
a preparation step 1 for a first metal-impregnated ceramic fired body, comprising impregnating a ceramic formed body with a metal by heating to a melting point of the metal or higher; and
a preparation step 2 for a second metal-impregnated ceramic fired body having a lower metal impregnation amount than the first metal-impregnated ceramic fired body, comprising removing a part of the metal impregnated in the first metal-impregnated ceramic fired body by reheating the first metal-impregnated ceramic fired body to the melting point of the metal or higher.

### (Preparation Step 1)

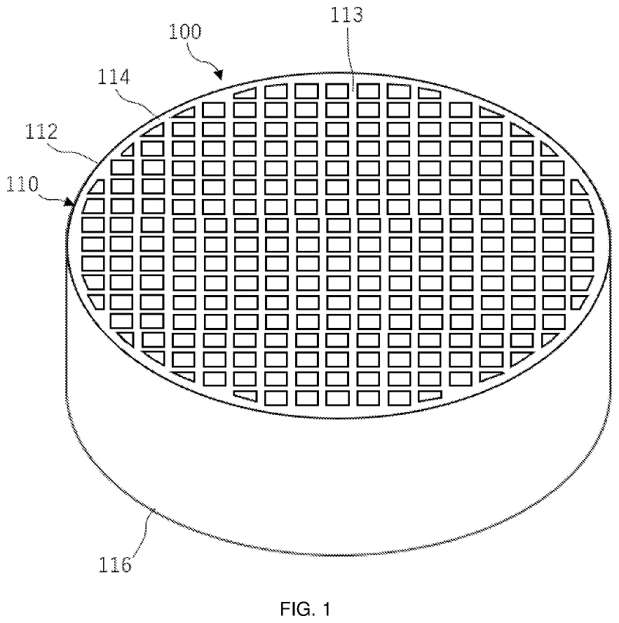

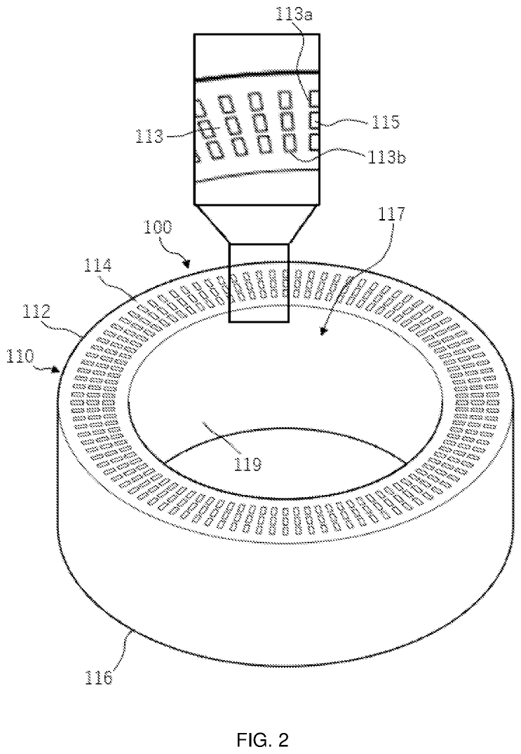

The preparation step 1 for the first metal-impregnated ceramic fired body comprises impregnating a ceramic formed body with a metal by heating to the melting point of the metal or higher. FIG. 1 shows a schematic perspective view of an example of a ceramic formed body 100. FIG. 2 shows a schematic perspective view of another example of the ceramic formed body 100. There are no particular restrictions on the shape of the ceramic formed body 100, but in one embodiment, the ceramic formed body 100 comprises a honeycomb structure portion 110 having an outer peripheral wall 112 and partition walls 113 disposed on the inner peripheral side of the outer peripheral wall 112 and partitioning a plurality of cells 115 forming flow paths from one end surface 114 to the other end surface 116. The external shape of the ceramic formed body 100 is typically pillar-shaped.

The shape of the end surfaces of the ceramic formed body 100 is not limited, and for example, it may be a round shape such as a circular, elliptical, racetrack and elongated circular shape, a polygonal shape such as a triangular and quadrangle shape, and other irregular shapes. The ceramic formed body 100 shown in FIG. 1 has a circular end surface shape and has a cylindrical shape as a whole.

Further, as shown in FIG. 2, the ceramic formed body 100 may have a hollow portion 117 extending from one end surface 114 to the other end surface 116. The hollow portion 117 is preferably formed coaxially with the central axis in the direction in which cells 115 of honeycomb structure portion 110 extend. In this case, the ceramic formed body 100 comprises a honeycomb structure portion 110 having an outer peripheral wall 112, an inner peripheral wall 119, and partition walls 113 disposed between the outer peripheral wall 112 and the inner peripheral wall 119, the partition walls 113 partitioning a plurality of cells 115 forming flow paths from one end surface 114 to the other end surface 116.

The height of the ceramic formed body 100 (the length from the one end surface to the other end surface) is not particularly limited and may be appropriately set according to the application and required performance. There is no particular limitation on the relationship between the height of the ceramic formed body 100 and the maximum diameter of each end surface (referring to the maximum length among the diameters passing through the center of gravity of each end surface of the ceramic formed body 100). Therefore, the height of the ceramic formed body 100 may be longer than the maximum diameter of each end surface, or the height of the ceramic formed body 100 may be shorter than the maximum diameter of each end surface.

The shape of the opening of the cells in the cross-section orthogonal to the direction in which the cells extend is not limited, and it is preferably quadrangle, hexagonal, octagonal, or a combination thereof. Among these, squares and hexagons are preferred. By making the shape of the opening of the cells as described above, the pressure loss when a fluid is allowed to flow through the cells 115 is reduced. In the honeycomb structure portion 110 of the ceramic formed body 100 shown in FIG. 1, most of the cell shapes in the cross-section perpendicular to the flow paths of the cells are square.

In a cross-section perpendicular to the direction in which the cells 115 extend, a plurality of cells 115 may be arranged radially. With such a configuration, the heat of the fluid flowing through the cells 115 can be efficiently transmitted to the outside of the honeycomb structure, which is advantageous when using the metal-impregnated ceramic fired body as a heat exchanger. In the honeycomb structure portion 110 of the ceramic formed body 100 shown in FIG. 2, a plurality of cells 115 are arranged radially. In a cross-section perpendicular to the direction in which the cells 115 extend, each of the plurality of cells 115 of the ceramic formed body 100 shown in FIG. 2 is partitioned by a pair of partition wall surfaces 113a extending from the center side of the honeycomb structure portion 110 toward the outer peripheral side, and the partition wall surfaces 113b on the center side and outer peripheral side connecting the pair of partition wall surfaces 113a. More specifically, each of the plurality of cells 115 of the ceramic formed body 100 shown in FIG. 2 is partitioned by a pair of linear partition wall surfaces 113a extending from the center side of the honeycomb structure portion 110 toward the outer peripheral side, and a pair of concentric arc partition wall surfaces 113b.

Cells 115 may extend through from one end surface 114 to the other end surface 116. Further, the cells 115 may be arranged such that first cells sealed on one end surface 114 and opening on the other end surface 116, and second cells opening on one end surface 114 and sealed on the other end surface 116, are alternately arranged adjacent to each other with the partition walls113 interposed therebetween.

The material of the ceramic formed body 100 is not particularly limited as long as it is ceramics. However, when using the metal-impregnated ceramic fired body as a heat exchanger, filter or catalyst carrier, it preferably comprises at least one selected from carbides such as silicon carbide, tantalum carbide and tungsten carbide, and nitrides such as silicon nitride and boron nitride, and more preferably comprises silicon carbide. The ceramic formed body 100 may contain only one type of ceramic component, or may contain two or more types in combination. The ceramic formed body 100 preferably contains 50% by mass or more, more preferably 70% by mass or more, and even more preferably 90% by mass or more of silicon carbide in the ceramic component.

A method of preparing the ceramic formed body 100 having the honeycomb structure portion 110 will be described. The ceramic formed body 100 having the honeycomb structure portion 110 can be manufactured according to a known honeycomb structure manufacturing method. For example, first, a binder, a surfactant, a pore-forming material, water, etc. are added to silicon carbide powder to prepare a forming raw material. Metallic silicon powder may be added to the forming raw material as required.

Next, after kneading the obtained forming raw material to form a green body, the green body is extrusion molded to prepare an undried ceramic formed body having the honeycomb structure portion. For extrusion molding, a die having a desired overall shape, cell shape, partition wall thickness, cell density, etc. can be used.

Next, by drying the obtained undried ceramic formed body, a dried ceramic formed body having the honeycomb structure portion 110 is obtained. In the drying step, conventionally known drying methods such as hot wind drying, microwave drying, dielectric drying, reduced pressure drying, vacuum drying, and freeze drying can be used. When sealing portions are necessary, they can be formed by forming the sealing portions at predetermined positions on both end surfaces of the dried ceramic formed body and then drying the sealing portions.

A metal can be impregnated into the ceramic formed body thus obtained. Impregnation can be carried out by heating to a temperature equal to or higher than the melting point of the metal while the ceramic formed body is in contact with the metal. The ceramic formed body subjected to the preparation step 1 may be the one before degreasing, the one after degreasing, or the one further fired after degreasing. However, from the viewpoint of production efficiency, energy cost, and the like, it is preferable to perform the preparation step 1 on a ceramic formed body 100 before degreasing. When the ceramic formed body has not been degreased, it is possible to efficiently manufacture a metal-impregnated ceramic fired body by continuously performing degreasing and firing. The firing furnace to be used is not particularly limited, but an electric furnace, a gas furnace, or the like can be used.

For the degreasing, for example, the atmosphere, temperature, and time may be appropriately set according to the type and amount of forming aids contained in the ceramic formed body, and the loading amount of the ceramic formed body per kiln, but it must be at least the decomposition temperature of the forming aids. For the firing, for example, the atmosphere, temperature, and time may be appropriately set according to the type of ceramics contained in the ceramic formed body, but it must be at least the melting point of the metal for impregnation. Assuming that the melting point of the metal for impregnation is M° C., and the maximum temperature during heating in step 1 is T1° C., for example, it is preferable that M≤T1≤M+300, more preferably M+20≤T1≤M+200, and even more preferably M+40≤T1≤M+150. However, even within this range, the temperature should be lower than the firing temperature of the ceramics constituting the ceramic formed body. For example, when the ceramic formed body contains silicon carbide and metallic silicon is used as the metal for impregnation, the maximum temperature T1 is preferably 1420 to 1720° C., more preferably 1440 to 1620° C., and even more preferably 1460 to 1570° C. The metal for impregnation heated to the melting point or higher melts and enters the pores in the ceramic formed body one after another due to capillary action, thereby realizing the impregnation. After heating, the metal-impregnated ceramic fired body is cooled to room temperature.

The form of the metal when the ceramic formed body is brought into contact with the metal for impregnating is not limited, but examples thereof include metal formed bodies and metal in the form of granules.

As used herein, the term “granules” refers to powders, grains, or a mixture of both, and refers to an aggregate of particles having a volume-based median diameter (D50) of 5000 μm or less when the particle size distribution is measured by a laser diffraction method. The lower limit of the median diameter of the metal in the form of granules is preferably 100 μm or more, more preferably 200 μm or more, and even more preferably 800 μm or more. By increasing the median diameter of the metal in the form of granules, it becomes easier to suppress strong adhesion of deposit derived from the metal in the form of granules to the surface of the ceramic formed body during impregnation. Further, the upper limit of the median diameter of the metal in the form of granules is preferably 3000 μm or less, more preferably 2000 μm or less, and even more preferably 1000 μm or less. Therefore, the median diameter of the metal in the form of granules is, for example, preferably 100 to 3000 μm, more preferably 200 to 2000 μm, even more preferably 800 to 1000 μm.

There are no particular restrictions on the type of metal for impregnation. However, it preferably comprises one or more selected from metallic silicon, molybdenum, tungsten, beryllium, chromium, iron, aluminum, nickel, manganese, silver, copper, vanadium, cobalt, tantalum, niobium, titanium, and magnesium, and more preferably comprises metallic silicon. The metal for impregnation may contain only one type of metal, or may contain two or more types in combination. The metal for impregnation may contain a single metal, or may contain an alloy.

In addition, when metal in the form of granules is used, in order to increase the fluidity during weighing, prevent excessive contact between particles constituting the granules when placed, about 30% by mass or less of auxiliary agents may be contained with respect to the metal in the form of granules. Desirable auxiliary agents include sugars having 20 or less carbon atoms, carbon, and the like.

In particular, when the ceramic formed body contains silicon carbide, it is preferable that the metal for impregnation contains metallic silicon. The metal for impregnation preferably contains 50% by mass or more, more preferably 70% by mass or more, and even more preferably 90% by mass or more of metallic silicon in the metal for impregnation. Preferably, metallic silicon may be contained in an amount of 99% by mass or more.

It is not necessary that the entire amount of the metal for impregnation is in contact with the ceramic formed body, and only a portion of the metal is required to be in contact. This is because, when the metal for impregnating is melted due to heating, it gradually permeates into the inside of the ceramic formed body due to capillary action. When the metal for impregnation is a formed body, it is preferable to perform impregnation by placing it on and/or under the ceramic formed body, for example. If the metal for impregnation is in the form of granules, a method of performing impregnation by placing the metal for impregnation under the ceramic formed body, a method of performing impregnation by placing the metal for impregnation in the hollow portion of the ceramic formed body, and a method of performing impregnation by placing the metal for impregnation in the cells of the honeycomb structure portion of the ceramic formed body are preferable, for example.

The amount of metal for impregnation may be appropriately set in consideration of the pore volume inside the ceramic formed body during firing, but it is preferably 50% or more, preferably 70% or more, and even more preferably 90% or more of the pore volume. As to the upper limit, when it is set to 120% or less, preferably 110% or less, and more preferably 105% or less, the formation of deposit after impregnation can be suppressed, and a situation in which the impregnation amount becomes excessive can be avoided. In addition, even if the impregnation amount is not excessive and sticking does not occur, the impregnation amount may be still adjusted to decrease by performing the preparation step 2, which will be described later.

In one embodiment, the first metal-impregnated ceramic fired body obtained through the above preparation step comprises one or more protrusions, i.e., sticking, formed by the metal for impregnation protruding on the surface. In addition, in another embodiment, the first metal-impregnated ceramic fired body may not have sticking.

### (Preparation Step 2)

The preparation step 2 for the second metal-impregnated ceramic fired body comprises removing a part of the metal impregnated in the first metal-impregnated ceramic fired body by reheating the first metal-impregnated ceramic fired body to the melting point of the metal for impregnation or higher. As a result, the second metal-impregnated ceramic fired body has a smaller metal impregnation amount than the first metal-impregnated ceramic fired body. If the first metal-impregnated ceramic fired body has sticking, it is possible to reduce or even eliminate the sticking. Even if the first metal-impregnated ceramic fired body does not have sticking, it is possible to adjust the physical properties by decreasing the impregnation amount.

When the first metal-impregnated ceramic fired body is reheated to the melting point of the metal for impregnation or higher, the metal is urged to vaporize. Therefore, by continuing heating, the metal impregnated in the first metal-impregnated ceramic fired body is gradually removed. At this time, by adjusting the reheating time, it is possible to precisely control the physical properties such as the thermal conductivity of the obtained second metal-impregnated ceramic fired body.

In order to increase the removal rate, the maximum temperature during reheating in the preparation step 2 is preferably higher than the maximum temperature during heating in the preparation step 1. Specifically, the maximum temperature during the reheating in the preparation step 2 is preferably 20° C. or higher, more preferably 40° C. or higher, and even more preferably 60° C. or higher than the maximum temperature during the heating in the preparation step 1. However, if the maximum temperature during the reheating in the preparation step 2 is set too high, the removal rate will be too high, making it difficult to finely adjust the impregnation amount or causing the fired body to deform. Therefore, for example, assuming the melting point of the impregnating metal is M ° C., and the maximum temperature during the reheating in the preparation step 2 is T2° C., for example, it is preferable that M+20≤ T2≤M+360, more preferable that M+40≤ T2≤M+340, and even more preferable that M+60≤ T2≤M+320. However, even within this range, T2 should be less than the firing temperature of the ceramics constituting the ceramic formed body. For example, when the ceramic formed body contains silicon carbide and metallic silicon is used as the metal for impregnation, the maximum temperature T2 is preferably 1440 to 1780° C., more preferably 1460 to 1760° C., even more preferably 1480 to 1740° C.

From the viewpoint of preventing redeposition of the metal, it is desirable to quickly move the vaporized metal away from the first metal-impregnated ceramic fired body. Also, the vaporization can be promoted by lowering the partial pressure of the vaporized metal in the atmosphere. Therefore, the pressure of the ambient gas during the reheating in the preparation step 2 is preferably lower than the pressure of the ambient gas during the heating in the preparation step 1. More specifically, it is preferable to perform the reheating in the preparation step 2 under a negative pressure environment by sucking ambient gas from the outside.

In addition, it is preferable that the preparation step 2 be accompanied by reheating the first metal-impregnated ceramic fired body while an absorbent is in contact with the first metal-impregnated ceramic fired body, thereby causing the absorbent to absorb the metal impregnated in the first metal-impregnated ceramic fired body. Reheating while contacting the absorbent allows the molten metal to be absorbed by the absorbent due to capillary force, thus making it possible to accelerate the removal rate of the metal. It is also possible to adjust the absorption amount by changing the dimensions of the absorbent.

In order to efficiently absorb metals, the absorbent is preferably porous. Although the lower limit of the porosity of the absorbent is not limited, for example, it is preferably 20% or more, more preferably 30% or more, and even more preferably 40% or more. Although the upper limit of the porosity of the absorbent is not particularly set, it is preferably 80% or less, more preferably 70% or less, and even more preferably 60% or less from the viewpoint of strength and decrease in capillary force due to increase in pore diameter. The porosity is measured, for example, by a mercury intrusion method conforming to JIS R1655:2003.

Also, it is desirable that the absorbent have good wettability to the metal used for impregnation. Therefore, it is preferable that the absorbent comprises 80% by mass or more, more preferably 90% by mass or more, and even more preferably 95% by mass or more in total of one or more selected from silicon carbide, carbon, and ceramic materials contained in the ceramic formed body.

There are no particular restrictions on the method of bringing the absorbent into contact with the first metal-impregnated ceramic fired body during the reheating in the preparation step 2. Therefore, the reheating may be performed in a state in which the absorbent is placed on and/or under the first metal-impregnated ceramic fired body and, or the reheating may be performed in a state in which the absorbent is placed on the side surface of the first metal-impregnated ceramic fired body. However, when the absorbent is placed on the first metal-impregnated ceramic fired body, the metal is sucked up only by capillary force, so there is an advantage that the physical properties are unlikely to deteriorate due to too much metal being sucked up. In addition, when the absorbent is placed under the first metal-impregnated ceramic fired body, the metal can be sucked out not only by the capillary force but also by gravity, so there is an advantage that a large amount of metal can be removed at once. Therefore, in a preferred embodiment, the reheating in the preparation step 2 is performed with the absorbent placed on and/or under the first metal-impregnated ceramic fired body, and in a more preferred embodiment, the reheating in the preparation step 2 is performed with the absorbent placed on the first metal-impregnated ceramic fired body.

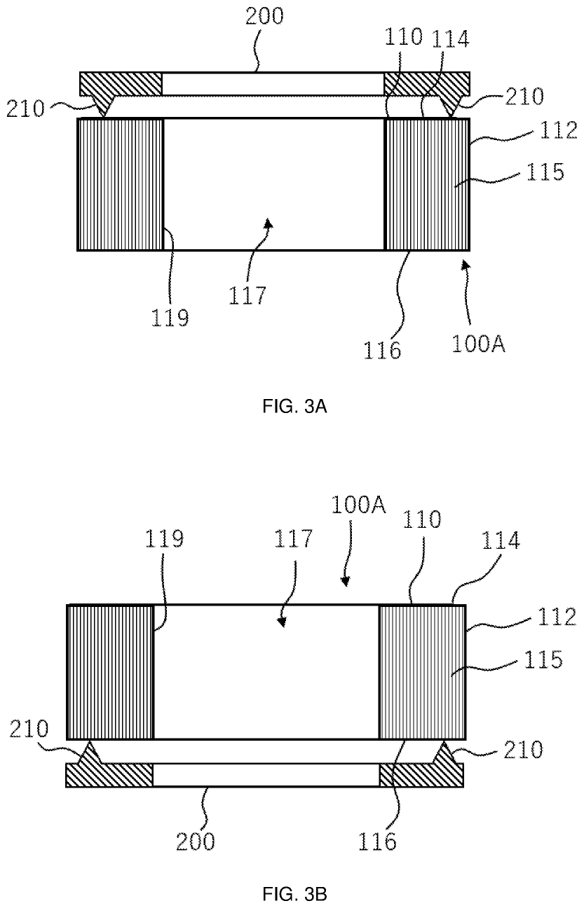

Here, FIG. 3A schematically shows a side cross-sectional view of a state in which the absorbent 200 is placed on the first metal-impregnated ceramic fired body 100A having the hollow portion 117 and the honeycomb structure portion 110. Further, FIG. 3B schematically shows a side cross-sectional view of a state in which the first metal-impregnated ceramic fired body 100A having the hollow portion 117 and the honeycomb structure portion 110 is placed on the absorbent 200.

The shape of the absorbent 200 is not particularly limited, but may be, for example, a plate shape or a hollow plate shape. In addition, in order to prevent the absorbent 200 from sticking to the first metal-impregnated ceramic fired body 100A, the contact area between the first metal-impregnated ceramic fired body 100A and the absorbent 200 is preferably small. In the embodiments shown in FIGS. 3A and 3B, the absorbent 200 has one or more protrusions 210, and the vertices of the protrusions 210 are in contact with the first metal-impregnated ceramic fired body 100A. Although there are no particular restrictions on the shape of the protrusion 210, for example, in addition to a shape that allows a point contact with the first metal-impregnated ceramic fired body 100A, a shape that allows a line contact may be used. Specifically, when the area (projected area) of the surface of the absorbent 200 facing the first metal-impregnated ceramic fired body 100A is 100%, the area of the contact portion between the first metal-impregnated ceramic fired body 100A and the absorbent 200 is, for example, 40% or less, preferably 30% or less. In addition, the lower limit of the area of the contact portion is typically 1% or more. Further, the contact area at each location can be, for example, 1 to 30 mm², typically 2 to 10 mm².

### (Metal-Impregnated Ceramic Fired Body)

The second metal-impregnated ceramic fired body obtained by performing the preparation step 2 can be used as it is as a metal-impregnated ceramic fired body product. Further, the second metal-impregnated ceramic fired body may be processed to obtain a metal-impregnated ceramic fired body as a product.

The porosity of the metal-impregnated ceramic fired body decreases as the impregnation amount increases. The porosity of the metal-impregnated ceramic fired body is preferably 30% or less, more preferably 20% or less, and even more preferably 10% or less, in order to ensure strength and thermal conductivity. The metal-impregnated ceramic fired body may have a porosity of 0%. The porosity is measured by the open porosity measurement method (Archimedes method) specified in JIS R1634:1998, but when the porosity exceeds 10%, it is measured by the mercury intrusion method in accordance with JIS R1655:2003.

When the metal-impregnated ceramic fired body has a honeycomb structure portion, the cell density (the number of cells per unit area) in the cross-section perpendicular to the direction in which the cells extend is not particularly limited, but is preferably 4 to 320 cells/cm2. By setting the cell density to 4 cells/cm2 or more, the strength of the partition walls 113, and the strength and effective GSA (geometric surface area) of the metal-impregnated ceramic fired body itself can be sufficiently ensured. Further, by setting the cell density to 320 cells/cm2 or less, it is possible to suppress an increase in pressure loss when a fluid flows through the cells. The cell density is calculated by dividing the number of cells in the honeycomb structure portion of the metal-impregnated ceramic fired body by the area of one end surface excluding the hollow portion, the outer peripheral wall and the inner peripheral wall.

The thickness of the partition walls 113 is not particularly limited, but it is preferably 0.1 to 1.0 mm, more preferably 0.2 to 0.6 mm, when the metal-impregnated ceramic fired body is used as a heat exchanger. By setting the thickness of the partition walls 113 to 0.1 mm or more, the mechanical strength of the metal-impregnated ceramic fired body can become sufficient. In addition, by setting the thickness of the partition walls 113 to 1.0 mm or less, it is possible to suppress problems such as an increase in pressure loss when a fluid is caused to flow through the cells 115 due to the decrease in the opening area, and a decrease in heat recovery efficiency due to the decrease in the contact area with the fluid.

The thicknesses of the outer peripheral wall 112 and the inner peripheral wall 119 are not particularly limited, but are preferably larger than the thickness of the partition walls 113. With such a configuration, it is possible to increase the strength of the outer peripheral wall 112 and the inner peripheral wall 119, which are likely to break (for example, cracks, fractures, or the like) due to thermal stress caused by the temperature difference between the fluids. The thicknesses of the outer peripheral wall 112 and the inner peripheral wall 119 are not particularly limited, and may be appropriately adjusted depending on the application. For example, the thickness of the outer peripheral wall 112 and the inner peripheral wall 119 is preferably 0.3 mm to 10 mm, more preferably 0.5 mm to 5 mm, and even more preferably 1 mm to 3 mm, when the metal-impregnated ceramic fired body is used for general heat exchange applications. Further, when the metal-impregnated ceramic fired body is used for heat storage applications, the outer peripheral wall 112 may have a thickness of 10 mm or more to increase the heat capacity of the outer peripheral wall 112.

### EXAMPLES

The following examples are provided for a better understanding of the invention and its advantages, but are not intended to limit the scope of the invention.

### (1. Preparation of Cylindrical Green Body)

Forming aids such as a binder and a pore-forming material were added to silicon carbide (SIC) powder, and water was added to obtain a forming raw material. Then, the forming raw material was kneaded by a vacuum kneader to prepare a cylindrical green body.

### (2. Preparation of Ceramic Formed Body)

The obtained cylindrical green body was formed using an extruder having a predetermined die structure, and a hollow cylindrical undried ceramic formed body having a honeycomb structure was obtained, such that each cell shape in the cross-section perpendicular to the direction in which cells extended was partitioned by a pair of linear partition wall surfaces extending from the center side toward the outer periphery side, and a pair of concentric arc partition wall surfaces, as shown in FIG. 2. This undried ceramic formed body was dried at 120° C. for 12 hours or more using a hot air dryer, and both end surfaces were cut in a predetermined amount. As a result, a required of number of hollow cylindrical dried ceramic formed bodies of height 25 mm, inner diameter 66 mm, and outer diameter 86 mm were prepared for the following tests.

### (3. Impregnation and Firing)

The dried hollow cylindrical ceramic formed body prepared above was oriented such that the direction in which the hollow portion and the cells extended were parallel to the vertical direction, and a hollow disk-shaped metallic silicon that matched the shape of the end surface of the ceramic formed body was placed on the upper surface (one end surface) of the hollow cylindrical ceramic formed body. In this state, the hollow cylindrical ceramic formed body was placed on a shelf board of a firing furnace and degreased under the heating conditions of 600° C. for 24 hours in a nitrogen atmosphere. After degreasing, the temperature was raised without cooling, and impregnation and firing were performed under the heating conditions of 1500° C.×2 hours in an argon atmosphere. After firing, the first Si-impregnated silicon carbide fired body was cooled to room temperature and taken out from the firing furnace.

The obtained Si-impregnated silicon carbide fired body according to each test example had the following specifications.
Overall shape: hollow cylindrical shape with a height of 25 mm, an inner diameter of 66 mm, and an outer diameter of 86 mm
Peripheral wall thickness: 2 mm
Inner peripheral wall thickness: 2 mm
Cell density: 56 cells/cm2
Partition wall thickness: 0.3 mm
Porosity: 0%

In addition, when the obtained first Si-impregnated silicon carbide fired body was observed, a plurality of protrusions (sticking) were confirmed on the end surfaces and the outer peripheral side face.

### (4. Removal of Sticking by Reheating)

The first Si-impregnated silicon carbide fired body obtained above was oriented such that the direction in which the hollow portions and the cells extended were parallel to the vertical direction, and an absorbent made of the same material as that of the ceramic formed body and formed into a hollow disk shape (porosity 45%, volume 23800 mm³ based on outer shape) that matched the end surface shape of the first Si-impregnated silicon carbide fired body was placed on the upper surface (one end surface) of the hollow cylindrical first Si-impregnated silicon carbide fired body. This absorbent had four protrusions protruding downward, and was brought into point contact with the first Si-impregnated silicon carbide fired body (contact area at each location=approximately 9 mm²). Further, when the area (projected area) of the surface of the absorbent facing the first Si-impregnated silicon carbide fired body is taken as 100%, the area of the contact portion of the first Si-impregnated silicon carbide fired body and the absorbent was 1.5%.

In this state, the hollow cylindrical first Si-impregnated silicon carbide fired body was placed on a shelf board of a firing furnace and reheated under the heating conditions of 1500° C.×2 hours in an argon atmosphere, thereby obtaining a second Si-impregnated silicon carbide fired body. After reheating, the second Si-impregnated silicon carbide fired body was cooled to room temperature and taken out from the firing furnace. When the obtained second Si-impregnated silicon carbide fired body was observed, it was found that the plurality of protrusions (sticking) on the end surfaces and the outer peripheral side surface, which had been confirmed in the first Si-impregnated silicon carbide fired body, had disappeared. In addition, the porosity of the second Si-impregnated silicon carbide fired body was 3 to 7%.

### DESCRIPTION OF REFERENCE NUMERALS

100: Ceramic formed body
100A: First metal-impregnated ceramic fired body
110: Honeycomb structure portion
112: Outer peripheral wall
113: Partition wall
113a: Partition wall surface
113b: Partition wall surface
114: End surface
115: Cell
116: End surface
117: Hollow portion
119: Inner peripheral wall
200: Absorbent
210: Protrusion

1. A method for manufacturing a metal-impregnated ceramic fired body, comprising:
a preparation step 1 for a first metal-impregnated ceramic fired body, comprising impregnating a ceramic formed body with a metal by heating to a melting point of the metal or higher; and
a preparation step 2 for a second metal-impregnated ceramic fired body having a lower metal impregnation amount than the first metal-impregnated ceramic fired body, comprising removing a part of the metal impregnated in the first metal-impregnated ceramic fired body by reheating the first metal-impregnated ceramic fired body to the melting point of the metal or higher.

2. The method according to claim 1, wherein the first metal-impregnated ceramic fired body comprises one or two or more protrusions formed by the metal protruding on a surface.

3. The method according to claim 1, wherein a maximum temperature during the reheating in the preparation step 2 is higher than a maximum temperature during the heating in the preparation step 1.

4. The method according to claim 1, wherein a pressure of an ambient gas during the reheating in the preparation step 2 is lower than a pressure of the ambient gas during the heating in the preparation step 1.

5. The method according to claim 1, wherein the preparation step 2 comprises reheating the first metal-impregnated ceramic fired body while bringing an absorbent into contact with the first metal-impregnated ceramic fired body, thereby causing the absorbent to absorb the metal impregnated in the first metal-impregnated ceramic fired body.

6. The manufacturing method according to claim 5, wherein the absorbent is porous.

7. The method according to claim 5, wherein the reheating in the preparation step 2 is performed with the absorbent placed on and/or under the first metal-impregnated ceramic fired body.

8. The method according to claim 5, wherein the absorbent contains 80% by mass or more in total of one or more selected from silicon carbide, carbon, and ceramic materials contained in the ceramic formed body.

9. The method according to claim 1, wherein the ceramic formed body comprises a honeycomb structure portion having an outer peripheral wall and partition walls disposed on an inner peripheral side of the outer peripheral wall and partitioning a plurality of cells forming flow paths from one end surface to another end surface.

10. The method according to claim 1, wherein the ceramic formed body contains silicon carbide, and the metal contains metallic silicon.

11. The method according to claim 1, wherein the metal-impregnated ceramic fired body is a heat exchanger.

12. The method according to claim 1, wherein the metal-impregnated ceramic fired body has a porosity of 30% or less.
